(19) United States
(12) Patent Application Publication
(10) Pub. No.: US 2022/0156682 A1
(43) Pub. Date: May 19, 2022

(54) DETERMINING THE SHARED FATE OF DAMAGED ITEMS WITHIN A SUPPLY CHAIN

(71) Applicant: Cisco Technology, Inc., San Jose, CA (US)

(72) Inventors: Pete Rai, Egham (GB); Joel Obstfeld, Bushey (GB)

(21) Appl. No.: 16/951,132

(22) Filed: Nov. 18, 2020

(51) Int. Cl. G06Q 10/08; G06N 20/00

(52) U.S. Cl. CPC G06Q 10/087; G06N 20/00; G06Q 10/0838

(57) ABSTRACT

According to one or more embodiments of the disclosure, a device obtains container data regarding a plurality of items to be shipped together in a container. The device generates, based on the container data, a damage prediction model that models physical relationships between the plurality of items within the container. The device receives sensor data associated with the container. The device predicts, using the damage prediction model, which of the plurality of items were damaged during transport of the container, based on the sensor data associated with the container.

### TECHNICAL FIELD

The present disclosure relates generally to computer networks, and, more particularly, to determining the shared fate of damaged items within a supply chain.

### BACKGROUND

Modern supply chains are complex and diverse systems. Every day, a great variety of cargo traverses the world and is tracked and controlled by a plethora of control systems. Increasingly, different types of cargo are being shipped together, including some that are vulnerable to damage while in transit.

As would be appreciated, damage to shipped items may occur due to a wide no variety of issues, such as a sharp impact or harsh handling of the cargo. Another source of damage may be exposure to adverse environmental conditions such as water, light, heat, radiation, etc. For instance, items such as food or medicines within a ‘cold chain’ can be subject to spoilage as a result of transport delays or breakdown of refrigeration units, etc. These are, just a few examples and there are many ways (and degrees) in which inventory can become damaged while within the supply chain.

As the management and control systems overseeing supply chains continue to become more aware of the context in which the inventory is moving, visibility into the state of inventory is also increasing. Indeed, cargo inventory is often tracked today as it moves from carrier to carrier and across different transport modalities (e.g., trucks, ships, trains, planes, etc.). At each exchange point, inventory quality is often attested to so that carriers can make clear that there was no damage to the inventory during their leg of the route. This means that when damage is detected, the source time, location, and method can often be accurately determined.

Increasingly, different types of inventory are shipped together, to optimize the supply chain. This means that one container may include a variety of items that are sharing the same route to the location of their recipient. Accordingly, the contents of the container often share the same fate, as damage to one item may carry through to another item, as well.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrate an example network;

FIG. 2 illustrates an example network device/node;

FIG. 3 illustrates an example of items being transported;

FIG. 4 illustrates an example of damage to items in a container;

FIG. 5 illustrates an example architecture for predicting damage to items; and

FIG. 6 illustrates an example simplified procedure for determining the shared fate of damaged items within a supply chain.

### DESCRIPTION OF EXAMPLE EMBODIMENTS

### Overview

According to one or more embodiments of the disclosure, a device obtains container data regarding a plurality of items to be shipped together in a container. The device generates, based on the container data, a damage prediction model that models physical relationships between the plurality of items within the container. The device receives sensor data associated with the container. The device predicts, using the damage prediction model, which of the plurality of items were damaged during transport of the container, based on the sensor data associated with the container.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, or Powerline Communications, and others. Other types of networks, such as field area networks (FANs), neighborhood area networks (NANs), personal area networks (PANs), etc. may also make up the components of any given computer network.

In various embodiments, computer networks may include an Internet of Things network. Loosely, the term “Internet of Things” or “IoT” (or “Internet of Everything” or “IoE”) refers to uniquely identifiable objects (things) and their virtual representations in a network-based architecture. In particular, the IoT involves the ability to connect more than just computers and communications devices, but rather the ability to connect “objects” in general, such as lights, appliances, vehicles, heating, ventilating, and air-conditioning (HVAC), windows and window shades and blinds, doors, locks, etc. The “Internet of Things” thus generally refers to the interconnection of objects (e.g., smart objects), such as sensors and actuators, over a computer network (e.g., via IP), which may be the public Internet or a private network.

Often, IoT networks operate within a shared-media mesh networks, such as wireless or Powerline Communication networks, etc., and are often on what is referred to as Low-Power and Lossy Networks (LLNs), which are a class of network in which both the routers and their interconnect are constrained. That is, LLN devices/routers typically operate with constraints, e.g., processing power, memory, and/or energy (battery), and their interconnects are characterized by, illustratively, high loss rates, low data rates, and/or instability. IoT networks are comprised of anything from a few dozen to thousands or even millions of devices, and support point-to-point traffic (between devices inside the network), point-to-multipoint traffic (from a central control point such as a root node to a subset of devices inside the network), and multipoint-to-point traffic (from devices inside the network towards a central control point).

Fog computing is a distributed approach of cloud implementation that acts as an intermediate layer from local networks (e.g., IoT networks) to the cloud (e.g., centralized and/or shared resources, as will be understood by those skilled in the art). That is, generally, fog computing entails using devices at the network edge to provide application services, including computation, networking, and storage, to the local nodes in the network, in contrast to cloud-based approaches that rely on remote data centers/cloud environments for the services. To this end, a fog node is a functional node that is deployed close to fog endpoints to provide computing, storage, and networking resources and services. Multiple fog nodes organized or configured together form a fog system, to implement a particular solution. Fog nodes and fog systems can have the same or complementary capabilities, in various implementations. That is, each individual fog node does not have to implement the entire spectrum of capabilities. Instead, the fog capabilities may be distributed across multiple fog nodes and systems, which may collaborate to help each other to provide the desired services. In other words, a fog system can include any number of virtualized services and/or data stores that are spread across the distributed fog nodes. This may include a master-slave configuration, publish-subscribe configuration, or peer-to-peer configuration.

Low power and Lossy Networks (LLNs), e.g., certain sensor networks, may be used in a myriad of applications such as for “Smart Grid” and “Smart Cities.” A number of challenges in LLNs have been presented, such as:

1) Links are generally lossy, such that a Packet Delivery Rate/Ratio (PDR) can dramatically vary due to various sources of interferences, e.g., considerably affecting the bit error rate (BER);

2) Links are generally low bandwidth, such that control plane traffic must generally be bounded and negligible compared to the low rate data traffic;

3) There are a number of use cases that require specifying a set of link and node metrics, some of them being dynamic, thus requiring specific smoothing functions to avoid routing instability, considerably draining bandwidth and energy;

4) Constraint-routing may be required by some applications, e.g., to establish routing paths that will avoid non-encrypted links, nodes running low on energy, etc.;

5) Scale of the networks may become very large, e.g., on the order of several thousands to millions of nodes; and
6) Nodes may be constrained with a low memory, a reduced processing capability, a low power supply (e.g., battery).

In other words, LLNs are a class of network in which both the routers and their interconnect are constrained: LLN routers typically operate with constraints, e.g., processing power, memory, and/or energy (battery), and their interconnects are characterized by, illustratively, high loss rates, low data rates, and/or instability. LLNs are comprised of anything from a few dozen and up to thousands or even millions of LLN routers, and support point-to-point traffic (between devices inside the LLN), point-to-multipoint traffic (from a central control point to a subset of devices inside the LLN) and multipoint-to-point traffic (from devices inside the LLN towards a central control point).

An example implementation of LLNs is an “Internet of Things” network. Loosely, the term “Internet of Things” or “IoT” may be used by those in the art to refer to uniquely identifiable objects (things) and their virtual representations in a network-based architecture. In particular, the next frontier in the evolution of the Internet is the ability to connect more than just computers and communications devices, but rather the ability to connect “objects” in general, such as lights, appliances, vehicles, HVAC (heating, ventilating, and air-conditioning), windows and window shades and blinds, doors, locks, etc. The “Internet of Things” thus generally refers to the interconnection of objects (e.g., smart objects), such as sensors and actuators, over a computer network (e.g., IP), which may be the Public Internet or a private network. Such devices have been used in the industry for decades, usually in the form of non-IP or proprietary protocols that are connected to IP networks by way of protocol translation gateways. With the emergence of a myriad of applications, such as the smart grid advanced metering infrastructure (AMI), smart cities, and building and industrial automation, and cars (e.g., that can interconnect millions of objects for sensing things like power quality, tire pressure, and temperature and that can actuate engines and lights), it has been of the utmost importance to extend the IP protocol suite for these networks.

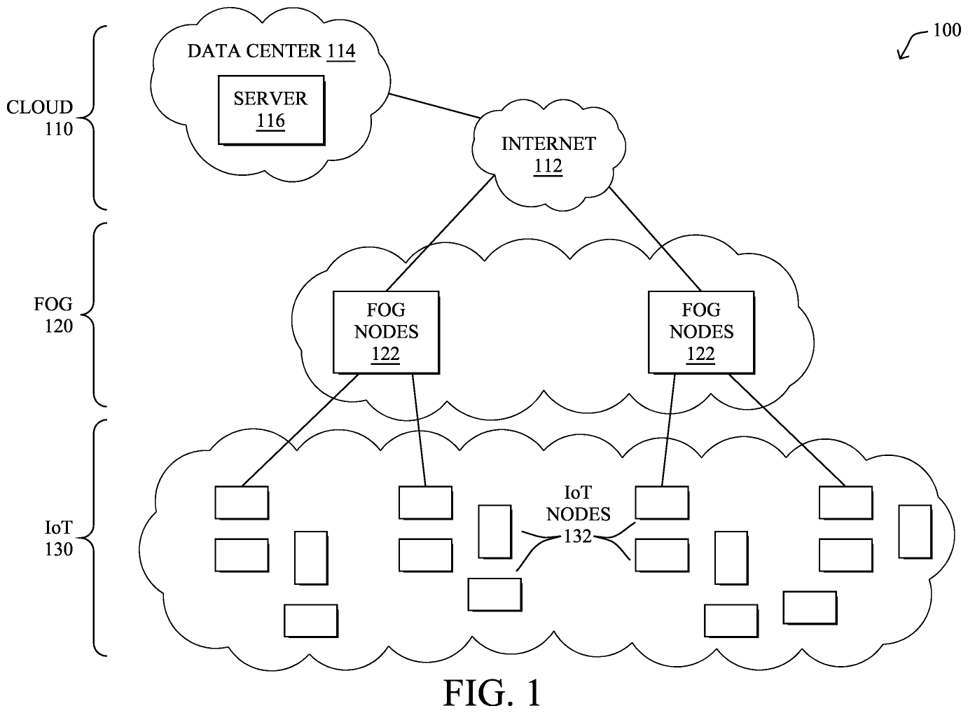

FIG. 1 is a schematic block diagram of an example simplified computer network 100 illustratively comprising nodes/devices at various levels of the network, interconnected by various methods of communication. For instance, the links may be wired links or shared media (e.g., wireless links, powerline communication links, etc.) where certain nodes, such as, e.g., routers, sensors, computers, etc., may be in communication with other devices, e.g., based on connectivity, distance, signal strength, current operational status, location, etc.

Specifically, as shown in the example network 100, three illustrative layers are shown, namely cloud layer 110, fog layer 120, and IoT device layer 130. Illustratively, the cloud layer 110 may comprise general connectivity via the Internet 112, and may contain one or more datacenters 114 with one or more centralized servers 116 or other devices, as will be appreciated by those skilled in the art. Within the fog layer 120, various fog nodes/devices 122 (e.g., with fog modules, described below) may execute various fog computing resources on network edge devices, as opposed to datacenter/cloud-based servers or on the endpoint nodes 132 themselves of the IoT device layer 130. For example, fog nodes/devices 122 may include edge routers and/or other networking devices that provide connectivity between cloud layer 110 and IoT device layer 130. Data packets (e.g., traffic and/or messages sent between the devices/nodes) may be exchanged among the nodes/devices of the computer network 100 using predefined network communication protocols such as certain known wired protocols, wireless protocols, powerline communication protocols, or other shared-media protocols where appropriate. In this context, a protocol consists of a set of rules defining how the nodes interact with each other.

Those skilled in the art will understand that any number of nodes, devices, links, etc. may be used in the computer network, and that the view shown herein is for simplicity. Also, those skilled in the art will further understand that while the network is shown in a certain orientation, the network 100 is merely an example illustration that is not meant to limit the disclosure.

Data packets (e.g., traffic and/or messages) may be exchanged among the nodes/devices of the computer network 100 using predefined network communication protocols such as certain known wired protocols, wireless protocols (e.g., IEEE Std. 802.15.4, Wi-Fi, Bluetooth®, DECT-Ultra Low Energy, LoRa, etc.), powerline communication protocols, or other shared-media protocols where appropriate. In this context, a protocol consists of a set of rules defining how the nodes interact with each other.

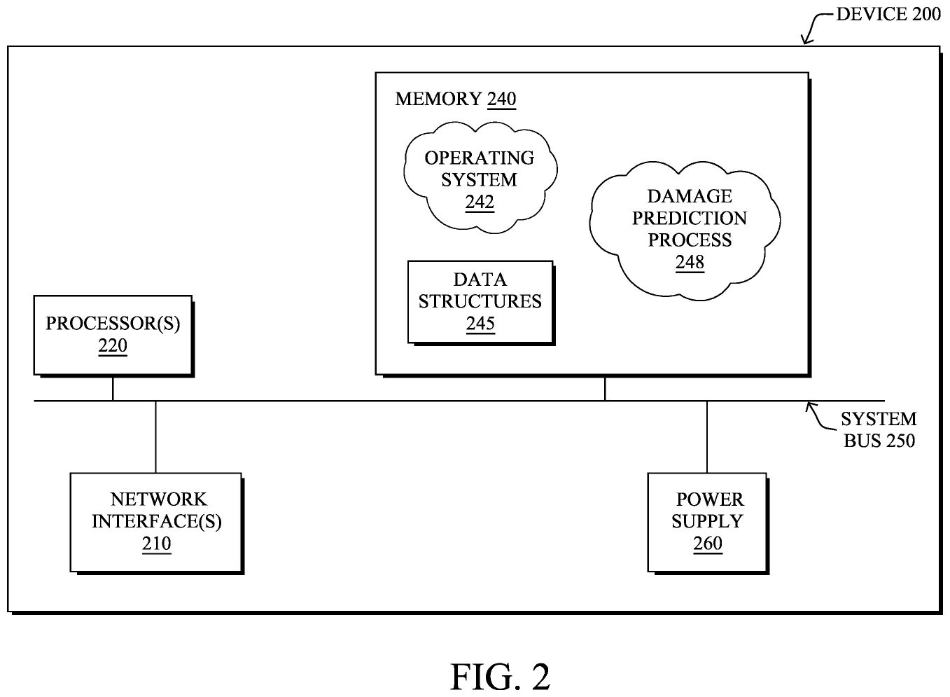

FIG. 2 is a schematic block diagram of an example node/device 200 that may be used with one or more embodiments described herein, e.g., as any of the nodes or devices shown in FIG. 1 above or described in further detail below. The device 200 may comprise one or more network interfaces 210 (e.g., wired, wireless, etc.), at least one processor 220, and a memory 240 interconnected by a system bus 250, as well as a power supply 260 (e.g., battery, plug-in, etc.).

Network interface(s) 210 include the mechanical, electrical, and signaling circuitry for communicating data over links coupled to the network. The network interfaces 210 may be configured to transmit and/or receive data using a variety of different communication protocols, such as TCP/IP, UDP, etc. Note that the device 200 may have multiple different types of network interfaces 210, e.g., wireless and wired/physical connections, and that the view herein is merely for illustration. Also, while the network interface 210 is shown separately from power supply 260, for powerline communications the network interface 210 may communicate through the power supply 260, or may be an integral component of the power supply. In some specific configurations the powerline communication signal may be coupled to the power line feeding into the power supply.

The memory 240 comprises a plurality of storage locations that are addressable by the processor(s) 220 and the network interfaces 210 for storing software programs and data structures associated with the embodiments described herein. The processor 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise a damage prediction process 248.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

In various embodiments, damage prediction process 248 may employ any number of machine learning techniques, to assess information obtained regarding a supply chain, to predict damage to items being transported via the supply chain. In general, machine learning is concerned with the design and the development of techniques that receive empirical data as input (e.g., container data regarding the items, sensor data from the shipping route, etc.) and recognize complex patterns in the input data. For example, some machine learning techniques use an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function is a function of the number of misclassified points. The learning process then operates by adjusting the parameters a,b,c such that the number of misclassified points is minimal. After this optimization/learning phase, damage prediction process 248 can use the model M to classify new data points, such as information regarding new containers, item configurations, and the like. Often, M is a statistical model, and the cost function is inversely proportional to the likelihood of M, given the input data.

In various embodiments, damage prediction process 248 may employ one or more supervised, unsupervised, or semi-supervised machine learning models. Generally, supervised learning entails the use of a training set of data, as noted above, that is used to train the model to apply labels to the input data. For example, the training data may include sample telemetry data that has been labeled as indicative of “damaged,” or “undamaged.” On the other end of the spectrum are unsupervised techniques that do not require a training set of labels. Notably, while a supervised learning model may look for previously seen patterns that have been labeled as such, an unsupervised model may instead look to whether there are sudden changes in the behavior of the system (e.g., anomalous conditions that may be indicative of item damage). Semi-supervised learning models take a middle ground approach that uses a greatly reduced set of labeled training data.

Example machine learning techniques that damage prediction process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), logistic or other regression, Markov models or chains, principal component analysis (PCA) (e.g., for linear models), multi-layer perceptron (MLP) ANNs (e.g., for non-linear models), replicating reservoir networks (e.g., for non-linear models, typically for time series), random forest classification, or the like.

The performance of a machine learning model can be evaluated in a number of ways based on the number of true positives, false positives, true negatives, and/or false negatives of the model. For example, the false positives of the model may refer to the number of items that the model incorrectly predicted as damaged. Conversely, the false negatives of the model may refer to the number of items that the model incorrectly predicted as being undamaged. True negatives and positives may refer to the number of items that the model correctly labeled as undamaged or damaged, respectively. Related to these measurements are the concepts of recall and precision. Generally, recall refers to the ratio of true positives to the sum of true positives and false negatives, which quantifies the sensitivity of the model. Similarly, precision refers to the ratio of true positives the sum of true and false positives.

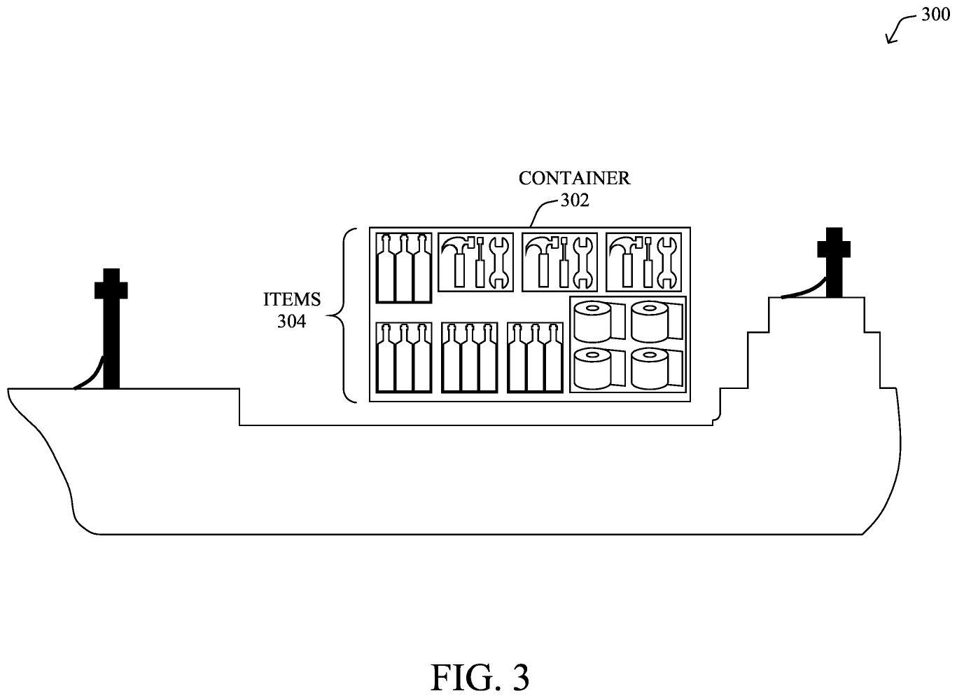

As noted above, supply chains are increasingly shipping different types of items together, to optimize their delivery. Consequently, these items often have a shared fate whereby damage to one of the items can result in damage to another item. For instance, consider the example cargo ship 300 in FIG. 3. As shown, there may be a variety of items 304 that are being shipped together within a container 302 being transported by cargo ship 300.

For instance, items 304 may include various items such as tools, bottles of wine, toilet paper, and the like. This means that items 304, to a certain degree, have a shared fate with respect to damage. In other words, damage to one item in items 304 may result in damage to one or more other items in items 304 transported within container 302. By way of example, assume that cargo ship 300 pitches during transit, resulting in container 302. As a result, a box of tools may fall within container 302, thereby breaking some of the bottles of wine, which then spill onto the rolls of toilet paper. In this case, even though the tools were the items 304 that were directly affected, other items in items 304 were also affected. Conversely, if a carton of toilet paper in items 304 falls over during transit of container 302, it may not have the catastrophic effects as in the case of tools falling over.

Typically, an inspection is performed when shipped goods are handed off from one carrier to another. For instance, when cargo ship 300 arrives at its destination port, an inspection may be performed, to container 302 for damage. However, it is often times impractical to remove all of items 304 from container 302 and, in many cases, the container remains locked and sealed until it reaches the termination point of its journey. It is only at this point where items 304 are unpacked and inspected. Thus, the damage to items 304 is often estimated and can even be missed, in some case.

——Determining the Shared Fate of Damaged Items within a Supply Chain——

The techniques herein allow for a probabilistic determination to be made of the damage (e.g., spoilage) of shipped items. In some aspects, the techniques herein may model the characteristics of the items that share the same fate, such as those shipped within the same container. In turn, the model may provide predictions as to whether any of the items have been damaged.

Illustratively, the techniques described herein may be performed by hardware, software, and/or firmware, such as in accordance with the damage prediction process 248, which may include computer executable instructions executed by the processor 220 (or independent processor of interfaces 210) to perform functions relating to the techniques described herein.

Specifically, according to various embodiments, a device obtains container data regarding a plurality of items to be shipped together in a container. The device generates, based on the container data, a damage prediction model that models physical qualities of items and the spatial relationships between the plurality of items within the container. The device receives sensor data associated with the container. In the event of a damage incident being detected, the device predicts, using the damage prediction model, which of the plurality of items were likely to have been damaged during transport of the container, based on the sensor data associated with the container.

Operationally, in some embodiments, a system is introduced that is able to predict damage to items being transported as cargo such as when bona-fide damage is identified. In some embodiments, a mature system could even predict damage when potential events are modeled. For example, the system could be used to answer the question “what would happen if I put these items here and those items there?” In turn, the system can probabilistically determine the shared fate of other inventory which had shared parts of the supply chain with the damaged item.

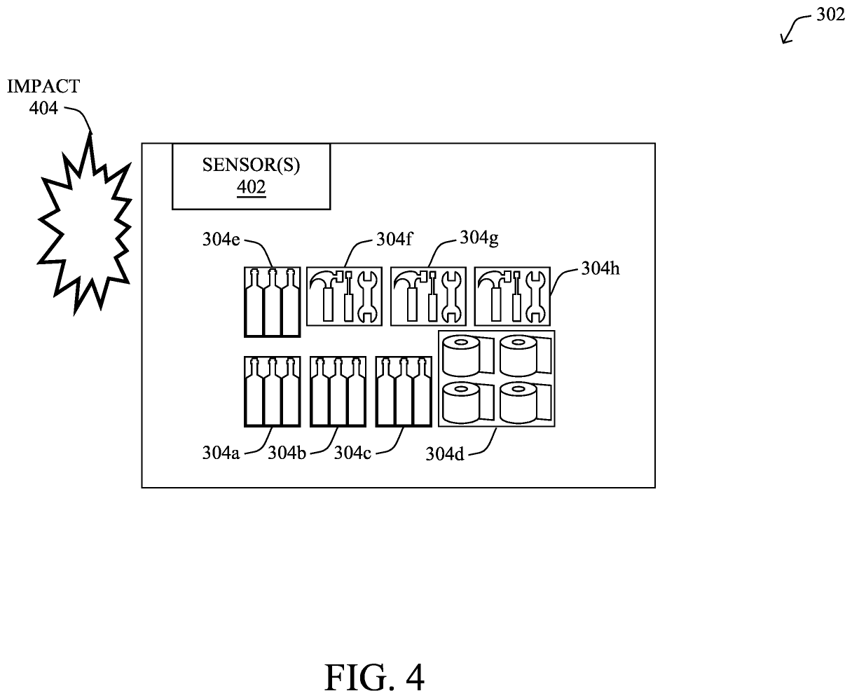

FIG. 4 illustrates an example of damage to items in a container, according to various embodiments. Continuing the example of FIG. 3, assume that container 302 is used to transport a plurality of items 304a-304h. In general, items 304a-304h may be of different types, as is becoming increasingly common among supply chains. For instance, if items 304a-304h are all destined for the same retailer, they may be shipped together, despite their differences.

In various embodiments, container data may be captured and tracked regarding the contents of container 302. For instance, container data regarding container 302 may include, but is not limited to, any or all of the following:
Physical characteristics of container 302—for instance, the container data may indicate the dimensions of container 302, its type (e.g., whether it's a parcel, truck, shipping container, etc.), construction material(s) (e.g., whether it is a carboard parcel, a metal shipping container, etc.), its shipping route(s), and the like.
Physical characteristics of items 304—for instance, the container data may also include information regarding the dimensions, weights, good types (e.g., wine, tools, toilet paper, etc.), shipping requirements (e.g., perishable goods that must be refrigerated to below a certain temperature, that an item should remain upright, etc.), states of matter (e.g., solid, liquid, gas, etc.), packaging information (e.g., bubble wrapped, layered protection, etc.), measures of vulnerability to damage associated with the items (e.g., whether an item has been flagged as fragile, etc.), tipping hazard information, radiation exposure information, and the like.
Location information for items 304 within container 302—this type of information may indicate how and where the various items 304a-304h are arranged within container 302 (e.g., that items 304d and 304h are located at the back of container 302, that item 304f was placed on top of item 304b, etc.). In further cases, this information may also indicate the orientations of the various items 304a-304h within container 302.
Shipping information for each of items 304 within container 302—this information may, for instance, indicate where each of items 304a-304h came from, where they are destined, and their paths of travel.

According to various embodiments, sensor(s) 402 may be located within container 302, affixed to the exterior of container 302, and/or may be located within proximity of the container so as to monitor the condition of the container. For instance, sensor(s) 402 may include, but are not limited to, any or all of the following: cameras, temperature sensors, pressure sensors, accelerometers, vibration sensors, tilt sensors, noise sensors, moisture sensors, radiation sensors, and the like. In further cases, sensor(s) 402 may also include sensors configured to capture input from a user. For instance, an inspector may operate a handheld or other portable electronic device, to indicate observed damage to any of items 304a-304h.

During use, sensor(s) 402 may capture information indicative of an event that has caused, or may cause, damage to any of items 304a-304h within container 302. For instance, say that an impact 404 has occurred with respect to container 302. In such a case, sensor(s) 402 may capture and report sensor data indicative of impact 404 occurring with respect to container 302, which may also indicate actual damage to any of items 304a-304h, as well. In turn, the system introduced herein may leverage the sensor data captured by sensor(s) 402, as well as the container data regarding container 302, to predict which of items 304a-304h were damaged by impact 304.

As would be appreciated, damage to shipped items may be caused by any number of different types of events. For instance, other events that could cause damage to shipped items may include, but are not limited to, any or all of the following: unregulated temperatures or temperatures outside of a specified range, flooding or other water damage, light exposure, exposure to radiation or other hazardous material, tilting of the container, and the like.

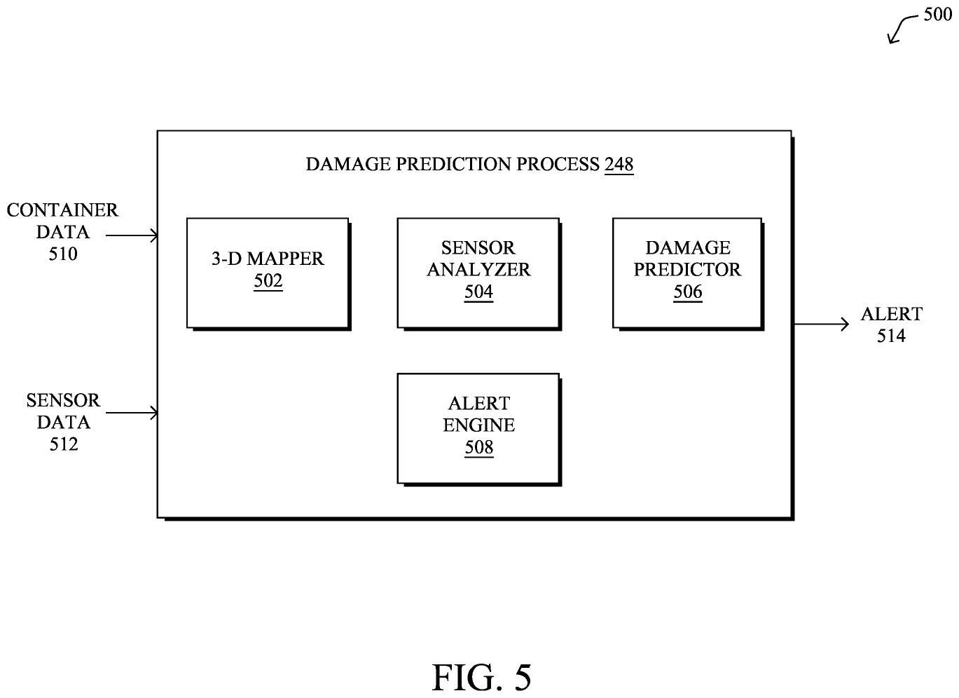

FIG. 5 illustrates an example architecture 500 for predicting damage to items, according to various embodiments. As shown, damage prediction process 248 may be configured to generate a damage prediction model for a particular container and that can be used to predict damage to any of its contents. To this end, damage prediction process 248 may include any or all of the following components: a three-dimensional (3-D) mapper 502, a sensor analyzer 504, a damage predictor 506, and/or an alert engine 508 that may operate in conjunction with one another to model a container and its contents. As would be appreciated, the functionalities of these components may be combined or omitted, as desired. In addition, these components may be implemented on a singular device or in a distributed manner, in which case the combination of executing devices can be viewed as their own singular device for purposes of executing damage prediction process 248.

During execution, damage prediction process 248 may obtain container data 510 regarding a particular container under scrutiny and its contents, as well as sensor data 512 captured regarding the container by one or more sensors. Such data may include any or all of the information described previously. In various embodiments, damage prediction process 248 may use container data 510 and sensor data 512 to evaluate the shared fate of items within the container dependent on any or all of the following factors:
The time and/or location of any damage to an actually damaged item (ADI)
The cause of the damage to the ADI
The physical state of a potentially damaged item (PIN)
Any known vulnerabilities of the PDI
The relative position, orientation and/or proximity of the PDI to the ADI
The history of the transit routes of both the PDI and the ADI

Note that ‘items’ referred to herein may be composite (e.g., multiple objects) or singular, for purposes of the techniques herein. For instance, multiple inventory items including liquids (bottles) and solids may be placed within a container for shipment. By way of example, a bottle of shampoo may constitute a single item during analysis and be inclusive of both its bottle and the shampoo within the bottle.

According to various embodiments, 3-D mapper 502 may use container data 510 to create a ‘map’ of the container under scrutiny. Such a map may, for instance, track the three-dimensional placement of items/inventory within the container, as well as the physical characteristics of the container and its contents, Note that in some cases, this map may be created automatically as part of an automated packing process for the container.

Sensor analyzer 504 may be configured to assess sensor data 512 to identify any events that may cause damage to the contents of the container, according to various embodiments. In turn, sensor analyzer 504 may associate such events with locations in the 3-D map of 3-D mapper 502. For instance, assume that during movement of the container, a sharp impact occurs impacting the top corner of the container. When this event is identified and recorded via sensor data 512, sensor analyzer 504 may ‘place’ information regarding the impact in the 3-D map generated by 3-D mapper.

In some embodiments, sensor analyzer 504 may also identify sensor data 512 indicative of actual damage to any items within the container. For instance, if a sensor located within a case of wine bottles detects breakage of one or more of the bottles, sensor analyzer 504 may flag the case as having been actually damaged. In other instances, sensor data 512 may include an indication from a human handler that the case of wine bottles was observed to be damaged, such as during a physical inspection of the container.

According to various embodiments, damage prediction process 248 may also include a damage predictor 506 that is configured to predict whether any particular items within the container have been damaged. In some instances, damage predictor 506 may, do so based on container data 510, sensor data 512, the 3-D map from 3-D mapper 502, and/or any actual damage identified by sensor analyzer 504. More specifically, damage predictor 506 may probabilistically determine, given an indication of actual damage to an item in the container, whether any of the other items in the container also sustained damage.

To illustrate the operation of damage predictor 506, consider again the example of u) a case of bottles that were damaged during transport. In such a case, damage predictor 506 may assess the data available to it, to assess which of the other items in the container may have been subjected to the spilled liquid from the bottles and which may have been far enough away to avoid also being damaged.

Various approaches may be used to implement damage predictor 506, such as machine learning (e.g., Bayesian inference, neural networking, etc.). To this end, damage predictor 506 may be trained to model the physical conditions and interactions within the container under scrutiny. For instance, damage predictor 506 may be trained using the laws of physics (e.g., the transfer of force, gravity, etc.), information about collisions, fluid dynamics, and the like, to extrapolate any damage inflicted upon one item to other item(s) within the same container.

Since damage prediction process 248 has knowledge of the items within the container, damage predictor 506 is also able to probabilistically determine which inventory will have been subjected to spoilage (e.g. packaging will have, been compromised or liquid will have been in direct contain with the inventory) or other damage, and which items within the container could be removed, cleaned and repackaged. In some embodiments, damage predictor 506 may also base this determination in part on any measures of vulnerability of damage associated with the PDIs within the container.

In further embodiments, in addition to probabilistically predicting damage to the items in the container, damage predictor 506 may also record and assess the transit route and location where any such damage was predicted to have occurred. This will enable damage prediction process 248 to establish hysteresis, enabling the system to build up sufficient information to be able to determine vulnerable points within the transit route where damage is known to occur. This movement record will further allow the system to determine whether the damage may have spread to additional boxes in the wider container, even if those boxes themselves exhibited no damage. For example, a cardboard box under the damaged box, may have also sustained water damage from damaged box above it in the container.

As would be appreciated, the dynamics of the travel itself may also help to spread damage and may be taken into account by damage predictor 506. For example, travel over an uneven road may spread more damage than over a smooth railway. This is a further probabilistic analysis that damage predictor 506 may perform, in some embodiments.

In various embodiments, damage prediction process 248 may also include alert engine 508, which is configured to provide, to a user interface, an indication that one or more of the items in the container under scrutiny were predicted by damage predictor 506 to have been damaged. For instance, if the probability of damage exceeds a certain threshold, alert engine 508 may send an alert to the user interface that the user should perform a physical inspection of the item(s) to determine whether the item(s) were subjected to actual damage. In other cases, the indication may trigger automated confirmation of the damage, such as through the use of cameras, weighting scales, or other sensors.

In a further embodiment, alert engine 508 may also receive feedback from the user interfaces to which it sent notifications regarding whether the item(s) that were predicted to have been damaged were actually damaged. In turn, damage prediction process 248 may use the feedback as part of its damage prediction model generation. In doing so, this allows damage prediction process 248 to leverage user feedback to become ‘smarter’ over time and, in turn, offer damage predictions of higher accuracy.

In yet further embodiments, information from alert engine 508 may be presented as a table, as a warning, as images, as content maps, as a virtual or augmented reality ‘view’ inside the container, etc.

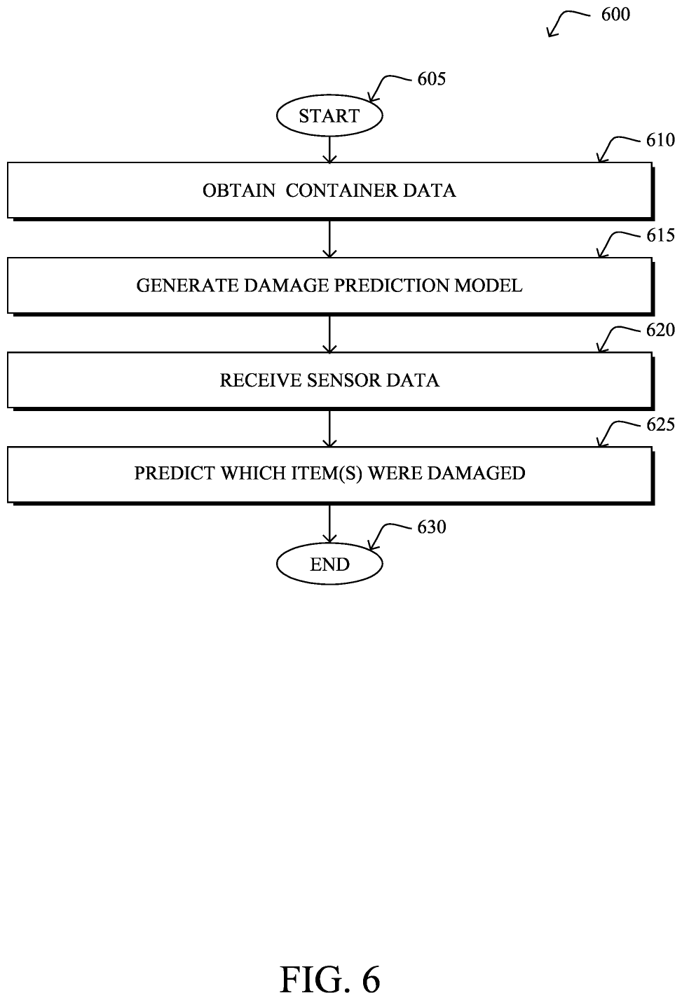

FIG. 6 illustrates an example simplified procedure for determining the shared fate of damaged assets within a supply chain, in accordance with one or more embodiments described herein. In various embodiments, a non-generic, specifically configured device (e.g., device 200) may perform procedure 600 by executing stored instructions (e.g., process 248), such as a server or other computing device. The procedure 600 may start at step 605, and continues to step 610, where, as described in greater detail above, the device may obtain container data regarding a plurality of items to be shipped together in a container. For instance, such container data may be indicative of the physical characteristics of the items (e.g., their sizes, weights, shapes, etc.), types (e.g., liquid, perishable, etc.), arrangement in the container, and the like.

At step 615, as detailed above, the device may generate a damage prediction model for the container. In various embodiments, the damage prediction model may be configured to model physical relationships between the plurality of items within the container. For instance, the damage prediction model may model the fluid dynamics of any liquid items within the container, the potential physical interactions of the items, and the like. In further embodiments, the model may also predict a spread of damage from an item confirmed to have received actual damage to one or more of the other items. In another embodiment, the damage prediction model may comprise a three-dimensional mapping of the plurality of items within the container. In yet another embodiment, the damage prediction model may be based in part on a history of transit routes of the plurality of items.

At step 620, the device may receive sensor data associated with the container, as described in greater detail above. In general, the sensor data may be generated by one or more sensors located internal to the container, affixed externally to the container, or within proximity of the container so as to monitor the condition of the container. For instance, the sensor data may be generated by any number of cameras, temperature sensors, pressure sensors, accelerometers, vibration sensors, tilt sensors, noise sensors, or the like.

At step 625, as detailed above, the device may predict, using the damage prediction model, which of the plurality of items were damaged during transport of the container. In turn, in some embodiments, the device may provide an indication that one or more of the items were predicted to have been damaged to a user interface (e.g., as part of an alert or other notification). Procedure 600 then ends at step 630.

It should be noted that while certain steps within procedure 600 may be optional as described above, the steps shown in FIG. 6 are merely examples for illustration, and certain other steps may be included or excluded as desired. Further, while a particular order of the steps is shown, this ordering is merely illustrative, and any suitable arrangement of the steps may be utilized without departing from the scope of the embodiments herein.

The techniques described herein, therefore, allow for the early identification of damage to items in a supply chain, which can save significant time, money, and other resources. Indeed, the standard approach to cargo damage today is to inspect the cargo when it arrives at its intermediate and/or final destination. This can require the entire to be undertaken once again, potentially in a reverse-logistics manner, to recover the damaged items from the end-customers. Further, evidence of damage has often to be sourced and exchanged before the liabilities can be apportioned. This can sour relationships and lead to a breakdown of trust. When damage is identified early, a great many negatives outcomes can be avoided and significant amounts of resources can be conserved. Further, by proactively identifying potential damage using the techniques herein, this can lead to improvements in the way in which items are packed, arranged, and transported. For instance, by identifying damage to items mid-journey, they can be sent back early or extracted and repaired, rather than waiting for the items to arrive at their destination in a damaged state.

While there have been shown and described illustrative embodiments for determining the shared fate of damaged assets, it is to be understood that various other adaptations and modifications may be made within the intent and scope of the embodiments herein. For example, while specific types of images and damage are described herein, the techniques herein are not limited as such and can be applied to a wide variety of different item and damage types. Further, while the techniques herein are described primarily with respect to items being transported, the techniques herein can also be used to predict damage to items being stored or housed in a warehouse or other environment, as well.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true intent and scope of the embodiments herein.

What is claimed is:

1. A method comprising:
obtaining, by a device, container data regarding a plurality of items to be shipped together in a container;
generating, by the device and based on the container data, a damage prediction model that models physical relationships between the plurality of items within the container;
receiving, at the device, sensor data associated with the container; and
predicting, by the device and using the damage prediction model, which of the plurality of items were damaged during transport of the container, based on the sensor data associated with the container.

2. The method as in claim 1, further comprising:
providing, by the device, an indication that one or more of the plurality of items were predicted to have been damaged to a user interface.

3. The method as in claim 1, wherein the sensor data is indicative of at least one of: an impact to the container or tilting of the container.

4. The method as in claim 1, wherein the damage prediction model comprises a three-dimensional mapping of the plurality of items within the container.

5. The method as in claim 1, wherein the container data regarding the plurality of items is indicative of one or more of: sizes, weights, or shapes of the plurality of items.

6. The method as in claim 1, wherein the container data regarding the plurality of items is indicative of at least one of the plurality of items comprising a liquid.

7. The method as in claim 1, wherein the sensor data associated with the container is indicative of at least one of the plurality of items receiving actual damage.

8. The method as in claim 7, wherein the damage prediction model is configured to predict a spread of damage from an item receiving actual damage to one or more of the plurality of items.

9. The method as in claim 1, wherein the container data regarding the plurality of items comprises measures of vulnerability to damage associated with one or more of the plurality of items.

10. The method as in claim 1, further comprising:
obtaining, by the device, a history of transit routes of the plurality of items, wherein the damage prediction model is generated in part based on the history of transit routes of the plurality of items.

11. An apparatus, comprising:
one or more network interfaces to communicate with a network;
a processor coupled to the one or more network interfaces and configured to execute one or more processes; and
a memory configured to store a process that is executable by the processor, the process when executed configured to:
obtain container data regarding a plurality of items to be shipped together in a container;
generate, based on the container data, a damage prediction model that models physical relationships between the plurality of items within the container;
ii receive sensor data associated with the container; and
predict, using the damage prediction model, which of the plurality of items were damaged during transport of the container, based on the sensor data associated with the container.

12. The apparatus as in claim 11, wherein the process when executed is further configured to:
provide an indication that one or more of the plurality of items were predicted to have been damaged to a user interface.

13. The apparatus as in claim 12, wherein the process when executed is further configured to:
receive feedback regarding whether the one or more of the plurality of items that were precited to have been damaged were actually damaged; and
generating a second future damage prediction model for a second container, based in part on the feedback.

14. The apparatus as in claim 11, wherein the damage prediction model comprises a three-dimensional mapping of the plurality of items within the container.

15. The apparatus as in claim 11, wherein the container data regarding the plurality of items is indicative of one or more of: sizes, weights, or shapes of the plurality of items.

16. The apparatus as in claim 11, wherein the container data regarding the plurality of items is indicative of at least one of the plurality of items comprising a liquid.

17. The apparatus as in claim 11, wherein the sensor data associated with the container is indicative of at least one of the plurality of items receiving actual damage.

18. The apparatus as in claim 11, wherein the process when executed is further configured to:
obtain a history of transit routes of the plurality of items, wherein the damage prediction model is generated in part based on the history of transit routes of the plurality of items.

19. The apparatus as in claim 11, wherein the container data regarding the plurality of items comprises measures of vulnerability to damage associated with one or more of the plurality of items.

20. A tangible, non-transitory, computer-readable medium storing program instructions that cause a device in a network to execute a process comprising:
obtaining, by the device, container data regarding a plurality of items to be shipped together in a container;
generating, by the device and based on the container data, a damage prediction model that models physical relationships between the plurality of items within the container;
receiving, at the device, sensor data associated with the container; and
predicting, by the device and using the damage prediction model, which of the plurality of items were damaged during transport of the container, based on the sensor data associated with the container.
